(19) United States
(12) Patent Application Publication
(10) Pub. No.: US 2004/0053799 A1
(43) Pub. Date: Mar. 18, 2004

(54) Prevention of hoof infections in livestock breeding

(76) Inventor: Alain Collin, Cachan/Frankreich (DE)

Correspondence Address: Andrew D. Sorensen, Ecolab Inc, Research and Development Center, 840 Sibley Memorial Highway, Mendota Heights, MN, 55118, US

(21) Appl. No.: 10/432,536

(22) PCT Filed: Nov. 15, 2001
(86) PCT No.: PCT/EP01/13222

(30) Foreign Application Priority Data
Nov. 24, 2000 (DE) 10058363.6

(51) Int. Cl. C11D 1/00

(52) U.S. Cl. 510/160

(57) ABSTRACT

The present invention relates to a method, agent and system of treating the hooves of agricultural animals, in particular in the field of livestock breeding, in which an as far as possible uninterrupted foam blanket or foam-like covering is produced on a surface, preferably on the stable floor, and the animals come into contact with the foam blanket or foam-like covering via their hooves during or after foam production.

The present invention relates to a method, agent and system for treating the hooves of agricultural animals, in particular in the field of livestock breeding.

Cattle, and also sheep, goats and breeding horses frequently suffer from diseases of the hoof, in particular as a result of inflammation of viral or bacterial origin between the hoof or toe ends; this inflammation, which is extremely painful, causes lameness or mobility problems, which result in the animal no longer feeding properly, which, in the case of cows for example, may result in reduced milk production.

As a consequence, these diseases, which are brought about by disease-transmitting microorganisms, cause the breeders serious problems, in particular since they may be transmitted from one animal to another.

It should be noted that these problems occur relatively seldom in animals which live out in the pasture and therefore move over large expanses of soft ground; they arise to a greater extent when the animals are kept constantly indoors, in particular in the case of so-called “free” stabling. In such stables, the animals are free to move within a restricted space, the floor of which generally consists of concrete or of concrete laths separated from one another by slits and laid over a pit, wherein the dung may be simply disposed of through the slits into the pit.

In practice, such surfaces cannot be kept in a perfect, hygienic state, such that it is inevitable that the animals stand and wade around in dirt and in particular in their own excrement.

These living conditions, coupled with the physical and mechanical stress resulting from the constant movement of the animals on a very hard floor, cause constant irritation in the hoof area; this expresses itself for example in softening of the horn layer in the area of the hoof ends. This makes the animals more susceptible to inflammatory diseases. In particular, those diseases which may be traced back to the numerous pathogens on the floor on which the animals move, spread more easily.

As mentioned above, these inflammatory conditions, which result in particular in abscesses between the hoof ends, are very painful and cause extraordinary sensitivity to touch, which makes local treatment of the inflamed areas very difficult, in particular the application of antibiotics to the skin.

As a consequence, the sole possible method of treatment is to administer antibiotics orally; however, it has been noted that such treatment becomes ever less effective, owing to the increasing resistance of the pathogens found in the dirt to the various antibiotics.

In order to counter these disadvantages, methods of treating the hooves of breeding animals, in particular cattle, have already been proposed which have as their aim not cure but prevention.

These methods consist in making the animals to be treated walk through foot baths, i.e. through large, shallow basins filled with disinfectant baths. These baths consist as a rule of highly concentrated solutions of formaldehyde and copper sulfate. They generally contain approximately 10% formaldehyde and 2% copper sulfate. In such solutions, the formaldehyde acts as disinfectant, whereas the copper sulfate has the task of strengthening the horn on the animals' hooves, to make them less sensitive to physical and mechanical stress.

However, such baths have not proven satisfactory. They are foul-smelling and cause skin irritation as a result of their high concentration of formaldehyde. In addition, such baths are environmentally questionable owing to the considerable quantities of copper sulfate therein.

However, the main disadvantage of these known treatment baths is associated with their inadequate microbicidal effect. When the animals walk through the foot bath, a large amount of protein-containing dirt is brought into the bath; the formaldehyde reacts preferentially with these organic residues, which impairs its antimicrobial activity against pathogens. The activity of such treatment baths thus decreases as a function of the life thereof.

Other disadvantages revealed in practice include a low level of wetting of the hooves or poor adhesion to the hooves and, associated therewith, a short contact time as well as, in particular in cold weather, the temperature-dependent activity of formaldehyde.

For the sake of completeness, it should be mentioned that foot baths containing antibiotics, for example tetracycline, have also already been proposed. However, the use of such baths on a large scale has not been seriously considered, since the basins have to be periodically emptied, to renew the treatment baths, such that considerable quantities of environmentally questionable antibiotics would enter the waste water.

WO 00/28917 proposes a method of treating the hooves of breeding animals, primarily cattle, in particular dairy cows, kept indoors, which method is sufficiently effective to relieve the above-mentioned inflammation in the hoof end area without causing skin irritation and at the same time without damaging the environment.

WO 00/28917 recommends a method in which, in a first stage, the hooves of the animals are cleaned with water or another cleaning agent containing soap or a surfactant by means of an automatic spray system to remove all traces of excrement, in particular dung or other contaminants, for example straw, whereupon, in a second stage, the pre-cleaned hooves of the animals are treated with a disinfectant by wetting or spraying.

The basic concept behind WO 00/28197 is thus to prevent the disinfectant in the treatment bath from being rapidly made ineffective by organic dirt stuck to the animals' hooves, by removing this dirt prior to application of the disinfectant in a previous cleaning stage.

Such cleaning has of necessity to be performed automatically. Manual cleaning is not desirable both because of the time the staff would need and because of the sensitivity to touch exhibited by the animals' hooves.

WO 00/28917 recommends that the animals to be treated preferably pass during the cleaning stage along a cleaning path which comprises spray racks at least on one side, preferably on both sides, which are equipped with a row of spray nozzles with which jets of water or cleaning agent under a given pressure may be directed at the hooves of the animals to be treated.

The cleaning path described in WO 00/28917 has a length of the order of 1 to 10 m, is preferably defined laterally by two vertical walls and bordered on both sides by two frames, to which two parallel racks with spray nozzles are attached, which spray nozzles are connected to a high pressure pump, by means of which water or a cleaning agent is supplied. The racks are covered with guard plates, so that they are not damaged by the animals as they pass through.

WO 00/28917 states that, during such cleaning, the dirt stuck to the animals' hooves is removed rapidly and reliably in fully automated manner and without manual contact and that in this way the disinfectant used next is prevented from becoming ineffective.

According to WO 00/28917, this disinfectant may either be applied in a foot bath located right at the end of the cleaning path or by means of a second automatic spray system similar to the automatic spray system for the cleaning agent and likewise located at the end of the cleaning path.

In accordance with WO 00/28917, the disinfectant may be applied either in liquid form or preferably in the form of a foam, which has the advantage of remaining longer on the animal's skin than a liquid agent, which extends the contact time with the disinfectants and consequently promotes the destruction of the pathogens on the animal's skin, in particular in the folds of the skin.

In addition, WO 00/28917 states that, where the treatment is intended for dairy cows, both the cleaning path and the device for applying the disinfectant are preferably arranged directly in front of the milking area. In this way, treatment will be performed compulsorily twice a day, namely before milking in the morning and before milking in the evening, and the disinfectant may act during the entire milking period, in order to ensure destruction of all the pathogens.

Despite the many advantages, there is a substantial disadvantage in the application of the technical teaching of WO 00/28917. In applying agents in the form of a foam to hooves, the problem arises that it is not generally possible to apply the foam in such a way that the entire area to be treated comes into contact with the disinfectant. Consequently, despite the advantages of the method, there remains a non-negligible risk of infection.

In addition, WO 00/28917 exhibits the disadvantage that, to solve the problem stated therein, namely the weakening or degradation of the disinfectant to be applied, a method comprising at least two stages is necessary. First of all cleaning is performed and then disinfection.

Accordingly, the object of the present invention was to provide a method in which the advantages of WO 00/28917 are retained while in addition it is ensured that the disinfectant comes into contact with the hooves as far as possible over the entire surface area to be treated by means of a simple procedure.

Consequently, the present invention provides a method for treating the hooves of agricultural animals, in particular in the field of livestock breeding, with foam or foam-like agents, characterised in that an as far as possible uninterrupted foam blanket or foam-like covering is produced on a surface, preferably on the stable floor, and the animals come into contact with the foam blanket or foam-like covering via their hooves during or after foam production. In the context of the present invention, the foam or foam-like covering should be understood to mean coverings for the production of which gas is blown into suitable liquids, or coverings which are produced by vigorous beating, shaking, spraying or stirring of the suitable liquid in the relevant gas atmosphere, wherein the liquid contains suitable surfactants or other surface-active agents (so-called foaming agents), which, in addition to their surface activity, also exhibit certain film-forming abilities.

It is preferable for the animals or the hooves thereof to come into contact with the foam blanket or foam-like covering in the stable area a short distance in front of the milking area.

In a preferred embodiment of the method according to the invention, the method is performed in such a way that the depth of the foam blanket on the stable floor amounts to more than 1 cm, particularly preferably more than 3 cm. This measure makes it possible to ensure that the animals come into contact with the foam or foam-like covering at points in the hoof area which are essential for treatment. The foam carpet should preferably not be deeper than 50 cm, particularly preferably not deeper than 30 cm.

The time for which the foam is in contact with the hooves preferably amounts to more than 1 minute, particularly preferably the foam or the foam-like covering remains in contact with the hooves for more than 3 minutes or even longer, for example during milking and optionally even after milking. In many cases, it may be preferable not to remove the foam, but to leave it on the hooves. Depending on the type, efficacy or tolerability of the agents used to produce the foam or the foam-like covering or on individual conditions or wishes, it may in practice likewise be preferable to rinse the animals' hooves with water after contact with the foam or foam-like covering. The foam or foam-like covering is preferably rinsed off less than 30 minutes after the hooves have come into contact with the foam or the foam-like covering.

In a further preferred embodiment of the method according to the invention, agents are added before, during or after production of the foam blanket or foam-like covering which ensure that the foam blanket or foam-like covering is not colourless or white. This should be understood to mean that the aforesaid chromophoric agents are used as auxiliary additives and serve primarily to provide colour and not to produce foam. Therefore, it is possible to introduce the chromophoric additives into the method according to the invention as desired before, during or after production of the foam or the foam-like covering. Dyeing takes away the animals' fear of stepping into the foam or foam-like covering.

This problem was observed with cows during practical testing of the method according to the invention. The cows came to a standstill in front of the white or colourless foam, while they stepped into the foam without a second thought when it had been dyed.

Within the context of the method according to the invention, to produce a foam blanket in the stable area a device is preferably so installed in the stable area that, when it is used, the area to be covered in foam, preferably the stable floor in front of the milking area, is adequately wetted with the foam or the foam-like covering.

It is particularly preferred that, in the aforesaid device, the meterable admixing of an agent suitable for foam production, supplied via a feed line, with a solvent, in particular water, flowing through a main line, be performed by means of an injector arranged in the main line, the suction opening of which injector is connected with the feed line, and by means of a flow control valve arranged in the feed line and foam is produced by means of an air feed line connected to the main line and arranged downstream of the injector in the direction of flow.

In a further preferred embodiment of the method according to the invention, an aqueous solution is used for foam production which contains at least one surface-active foam stabilising component and at least one antimicrobially active component.

It is particularly preferred that, for production of the aforesaid aqueous solution

a) one or more agents be diluted with water, preferably by a factor of 20 to 200 and

b) where a plurality of agents are used, the respectively diluted solutions be mixed together, wherein

the at least one surface-active foam stabilising component and the at least one antimicrobially active component are contained together in one agent and/or individually in a plurality of agents.

The aforesaid surface-active foam stabilising component is preferably selected from the tertiary amine oxides of the general formula (A)

wherein R¹ denotes a saturated or a mono- to triunsaturated branched or unbranched alkyl group with 10 to 20 C atoms and R² and R³ mutually independently denote methyl, ethyl or propyl residues or the hydroxy derivatives thereof and/or the alkylpolyglycosides of the general formula (B)

R⁴—O—(R⁵—O)_{y}(Z)ₓ (B)

wherein R⁴ denotes a monovalent, saturated or unsaturated alkyl or hydroxyalkyl residue comprising 6 to 30 C atoms or an aryl residue, R⁵ denotes a divalent hydrocarbon residue with 2 to 4 C atoms, y denotes a number between 0 and 12, Z a sugar residue with 5 or 6 C atoms and x a number between 1 and 10, and/or the quaternary ammonium compounds of the general formula C

in which the individual parts, independently of one another, have the following meaning:

R⁶=alkyl, alkenyl or aryl group with 1 to 6 C atoms

R⁷,R⁸,R⁹=alkylene group with in each case 2 to 4 C atoms

R¹⁰,R¹¹,R¹²=hydrogen or aliphatic or aromatic acyl group with 6 to 20 C atoms, wherein at most 2 of the residues R⁵ to R⁷ may be hydrogen,

Y^{o}=inorganic or organic anion.

Particularly preferred amine oxides are those in which the substituents R2 and R³ denote 2 hydroxyethyl residues. Examples of such amine oxides are tallow fat bis(2-hydroxyethyl)amine oxide, oleyl bis(2-hydroxyethyl)amine oxide, coconut bis(2-hydroxyethyl)amine oxide. Other amine oxides preferred in this context are tetradecyldimethylamine oxide and/or other alkyldimethylamine oxides which comprise 12 to 18 carbon atoms in the alkyl chain, such as for example lauryldimethylamine oxide or myristyldimethylamine oxide.

The alkylpolyglycosides preferably contained in at least one or more agents to be diluted constitute a nonionic class of surfactant, the alkyl groups of which originate from natural fats, oils or petrochemically produced alcohols and the sugar residues thereof from hydrolytically cleaved polysaccharides. The alkylpolyglycosides constitute etherification products of fatty alcohols of fat chemical or petrochemical origin with mono- or oligosaccharides, wherein the sugar residues may additionally be alkoxylated prior to etherification with the fatty alcohols. In this way, alkylpolyglycosides of the general formula (II) are obtained, which are described in more detail in WO 86/05199 for example. Industrial alkylpolyglycosides are not as a rule molecularly uniform products, but rather constitute alkyl ethers of mixtures of mono- and various oligosaccharides. In the context of the present invention, such alkylpolyglycosides, also abbreviated to APG, are particularly preferred which are based on non-ethoxylated sugars, i.e. those in which y in the general formula (II)=0. A glucose residue is preferably used as the sugar residue Z which is present as a single glucose unit or as an oligoglucose unit with up to approximately 5 glucose groups. The alkyl residue R⁴ preferably stands for a saturated or unsaturated alkyl residue with 8 to 16 C atoms, preferably with 8 to 10 C atoms, or mixtures thereof.

The quaternary ammonium salts of formula III preferably contained in at least one or more agents to be diluted are saturated or unsaturated quaternary-ammonium salts which arise from the esterification of trialkanolamine, preferably triethanolamine, with fatty acids and subsequent quaternisation with suitable alkylation agents. Fatty acids deserving of special mention are those with 12 to 18 C atoms, for example lauric acid, myristic acid, palmitic acid, oleic acid or stearic acid, wherein the industrially occurring mixtures of fatty acids are preferably used, for example the acid mixtures derived from coconut fat, palm kernel oil, rape-seed oil or tallow fat. These so-called ester quats contain on average 1 to 3 ester groups per molecule, wherein on average at least 2 ester groups are preferably contained therein. As counterions, the ester quats preferably contain halide, in particular chloride, sulfate, methyl sulfate, methyl phosphate and alkyl or aryl sulfonate.

Owing to the foaming action of quaternary ammonium salts, it may also be preferable, however, to use conventional, commercially available QACs as foam stabilising components.

The aforesaid antimicrobially active component is preferably selected from the groups comprising alcohols, aldehydes, antimicrobial acids, carboxylic acid esters, acid amides, phenols, phenol derivatives, diphenyls, diphenylalkanes, urea derivatives, oxygen, nitrogen acetals and formals, benzamidines, isothiazolines, phthalimide derivatives, pyridine derivatives, guanidines, chlorohexidines, alkylamines, alkyldiamines, alkyltriamines, antimicrobial amphoteric compounds, quinolines, 1,2-dibromo-2,4-dicyanobutane, iodo-2-propynyl butylcarbamate, iodine, iodophores, peroxides and per-acids.

It is particularly preferable for the aforesaid antimicrobially active component to represent an organic per-acid, preferably selected from among

a) the per-acids or salts of per-acids with the general formula I

R²—O₂C—(CH₂)_{x—CO}₃H (I)

in which R² is hydrogen or an alkyl group of 1 to 4 carbon atoms and x is a number from 1 to 4, and/or

b) phthalimidopercarboxylic acids (II), in which the percarboxylic acid fraction contains 1 to 18 carbon atoms, and/or

c) the compounds of the formula III

R¹—CO₃H (III)

in which R¹ is an alkyl or alkenyl group with 1 to 18 carbon atoms.

It is very particularly preferable for the aforesaid per-acids to be selected from among

a) per-acids of the general formula I, in which R² is hydrogen or a methyl group, and/or

b) phthalimido per-acids, in which the percarboxylic acid fraction contains 1 to 8 carbon atoms, and/or

c) per-acids of the general formula III with an alkyl or alkylene group with 1 to 12 carbon atoms.

The aforesaid per-acids are very especially selected from among peracetic acid, perpropionic acid, peroctanoic acid, phthalimidoperhexanoic acid, phthalimidoperoctanoic acid, persuccinic acid, persuccinic acid monomethyl ester, perglutaric acid, perglutaric acid monomethyl ester, peradipic acid, peradipic acid monomethyl ester, perbutanedioic acid, perbutanedioic acid monomethyl ester.

Owing to its economic and environmental advantages and its characteristics under industrial conditions, the per-acid worthy of particular mention is peracetic acid.

The proportion of antimicrobially active component in at least one or more of the agents to be diluted is preferably between 0.2 and 30 wt. %, preferably between 2 and 20 wt. %, relative to the total agent.

Fatty acids with 8 to 12 carbon atoms are preferably additionally contained in at least one or more agents to be diluted.

It is preferred, particularly when one of the aforesaid organic per-acids is present, that an anionic surfactant, preferably selected from C₈-C₁₈ alkyl sulfates, C₈-C₁₈ alkyl ether sulfates, C₈-C₁₈ alkane sulfonates, C₈-C₁₈ α-olefin sulfonates, sulfonated C₈-C₁₈ fatty acids, C₈-C₁₈ alkylbenzenesulfonates, sulfobutanedioic acid mono- and di-C₁-C₁₂-alkyl esters, C₈-C₁₈ alkylpolyglycol ether carboxylates, C₈-C₁₈ N-acyl taurides, C₈-C₁₈ N-sarcosinates, C₈-C₁₈ alkylisethionates and mixtures of the above is additionally contained in at least one of the agents to be diluted in accordance with the method according to the invention.

In another preferred embodiment of the method according to the invention, chromophoric components are additionally contained in at least one of the agents to be diluted. In this way, the optionally desired colour of the foam or the foam-like covering is introduced by the agent to be produced. As already stated, this takes away the animals' fear of stepping into the foam carpet.

Depending on the intended use, additional components may be contained in the agent(s) to be diluted in accordance with the method according to the invention, for example alkalis, chelating agents, builder substances, additional anionic and/or nonionic surfactants, enzymes and/or perfumes, skin-care components.

Suitable alkalis are for example sodium or potassium hydroxide, sodium or potassium carbonate and sodium or potassium silicates. Suitable chelating agents are for example alkali metal salts of ethylenediaminetetraacetic acid (EDTA) or nitrilotriacetic acid (NTA) and alkali metal salts of anionic polyelectrolytes such as polyacrylates, polymaleates and polysulfonates. Also low molecular weight hydroxycarboxylic acids such as citric acid, tartaric acid, malic acid or gluconic acid. Suitable complexing agents may additionally be selected from among organophosphates such as for example 1-hydroxyethane-1,1-diphosphonic acid, aminotri(methylenephosphonic acid), hexamethylenediamine-tetra(methylenephosphonic acid), diethylenetriamine-penta(methylenephosphonic acid) and 1-phosponobutane-1,2,4-tricarboxylic acid.

Examples of additional anionic or nonionic surfactants which may additionally be used in the context of the formulation according to the invention are: alkyl sulfates and sulfonates together with alkylbenzenesulfonates of fat chemical or petrochemical origin together with alkoxylation products of fatty alcohols or fatty amines. The alkoxylates may be terminated with alkyl groups, for example butyl groups and be present as fatty alcohol or fatty amine oligoglycol ethers. In this way, the foaming behaviour of the cleaning agents according to the invention may be controlled.

The present invention additionally provides an agent for preventing hoof infection, containing at least one surface-active foam stabilising component and at least one antimicrobially active component together with at least one chromophoric component.

The foam stabilising component and antimicrobially active component preferably comprise the substances preferably contained in one or more agents to be diluted and described in relation to the method according to the invention.

The present invention additionally provides an agent for preventing hoof infection, containing at least one surface-active foam stabilising component and at least one antimicrobially active component selected from

a) the per-acids or salts of per-acids with the general formula I

R²—O₂C—(CH₂)ₓ—CO₃H (I)

in which R² is hydrogen or an alkyl group of 1 to 4 carbon atoms and x is a number from 1 to 4, and/or

b) phthalimidopercarboxylic acids (II), in which the percarboxylic acid fraction contains 1 to 18 carbon atoms, and/or

c) the compounds of the formula III

R¹—CO₃H (III)

in which R¹ is an alkyl or alkenyl group with 1 to 18 carbon atoms.

The present invention likewise provides a system for treating the hooves of agricultural animals, in particular in the field of livestock breeding, containing one or more agents to be diluted in accordance with the method according to the invention and a device for use in accordance with the method according to the invention.

The present invention further provides a system for treating the hooves of agricultural animals, in particular in the field of livestock breeding, containing an agent for use in accordance with the method according to the invention and a device for use in accordance with the method according to the invention together with an additional chromophoric agent for separate use in accordance with the method according to the invention.

### EXAMPLES

The method according to the invention was tested in practical trials over a relatively long period. For this purpose, 4 suitable farms were selected with stock consisting of between 35 and 330 dairy cows. According to information provided by the farms, the average milk yield of these cows was approximately 8000 kg per year.

All the farms had the problem that a large proportion of the dairy cows suffered from digital dermatitis (Mortellaro), as was clear from their symptoms. On average, 23 to 41% of the dairy cows limped. Henkel-Ecolab products were used as foam-producing products, namely P3-Kovex Foam Activator®, which contains as its substantial constituents approximately 7.5 wt. % coconut amine oxide and approximately 0.2 wt. % of a suitable chromophoric component in aqueous solution, and P3-Kovex Foam Base, which contains as its substantial constituents, in accordance with the formulation, approximately 2 wt. % coconut amine oxide, approximately 10 wt. % acetic acid and approximately 10 wt. % hydrogen peroxide, together with approximately 0.5 wt. % of a phosphonic acid in aqueous solution, wherein, in the finished formulation, peracetic acid is present in equilibrium in a concentration of approximately 1.5 wt. %, relative to the total agent. Each of the aforesaid products was initially diluted with water by a factor of approximately 1:50. After mixing of the two aqueous solutions, foam production was performed automatically by means of a commercial foaming apparatus.

The foam was applied to the floor of the waiting area in front of the milking area, whereby a foam coating arose with an average thickness of 5 cm. Owing to the green colour of the foam blanket, the cows were not dazzled and walked happily into the green-coloured foam. The cows stood for approximately 5 to 10 minutes in the foam blanket and were then taken away for milking.

The number of sick cows was initially determined before the start of the first foam application at the time to. In the present trial, for the sake of simplicity, the number of sick cows was equated with the number of cows that limped noticeably. Approximately 40 days after the first foam application the number of sick cows was again established, at the time t₁. In a third stage, the number of sick cows was established after approximately 90 days at the time t₂. Throughout the trial period, the foam was applied as described at approximately 4-day intervals. The results are contained in Table 1.

TABLE 1
Testing of method, agent and system according to
the invention in 4 practical trials

| | | Sick | | | | | |
|---|---|---|---|---|---|---|---|
| Practical | Total no. | cows at t₀ | | Sick cows at t₁ | | Sick cows at t₂ | |
| trial | of cows | No. | as % | No. | as % | No. | as % |
| Example 1 | 85 | 35 | 41 | 3 | 4 | 4 | 5 |
| Example 2 | 35 | 8 | 23 | 1 | 3 | 2 | 6 |
| Example 3 | 320 | 82 | 26 | 2 | 1 | 6 | 2 |
| Example 4 | 55 | 24 | 44 | 4 | 7 | 3 | 5 |

During the period of the trial, no irritation was noted on the hooves, legs or udders. It could also be noted that the cows were not dazzled owing to the dye.

In particular, it was observed that application of the present invention allowed the occurrence of digital dermatitis, measured on the basis of noticeably limping cows, to be reduced by 75 to 98%.

1. A method for treating the hooves of agricultural animals, in particular in the field of livestock breeding, with foam or foam-like agents, characterised in that an as far as possible uninterrupted foam blanket or foam-like covering is produced on a surface, preferably on the stable floor, and the animals come into contact with the foam blanket or foam-like covering via their hooves during or after foam production.

2. A method according to claim 1, characterised in that the animals come into contact with the foam blanket or foam-like covering in the stable area a short distance in front of the milking area.

3. A method according to one of claims 1 or 2, characterised in that the depth of the foam blanket on the stable floor amounts to more than 1 cm.

4. A method according to one or more of claims 1 to 3, characterised in that the time for which the foam is in contact with the hooves preferably amounts to more than 1 minute.

5. A method according to one or more of claims 1 to 4, characterised in that agents are added before, during or after production of the foam blanket or foam-like covering which ensure that the foam blanket or foam-like covering is not colourless or white.

6. A method according to one or more of claims 1 to 5, characterised in that, to produce a foam blanket in the stable area, a device is preferably installed in the stable area in such a way that, when it is used, the area to be covered in foam, preferably the stable floor in front of the milking area, is adequately wetted with the foam or the foam-like covering.

7. A method according to claim 6, characterised in that, in the device, the meterable admixing of an agent suitable for foam production, supplied via a feed line, with a solvent, in particular water, flowing through a main line, is performed by means of an injector arranged in the main line, the suction opening of which is connected with the feed line, and by means of a flow control valve arranged in the feed line and foam is produced by means of an air feed line connected to the main line and arranged downstream of the injector in the direction of flow.

8. A method according to one or more of claims 1 to 7, characterised in that an aqueous solution is used for foam production which contains at least one surface-active foam stabilising component and at least one antimicrobially active component.

9. A method according to claim 8, characterised in that, for production of the aforesaid aqueous solution
c) one or more agents are diluted with water, preferably by a factor of 20 to 200 and
d) where a plurality of agents are diluted, the respectively diluted solutions are mixed together, wherein
e) the at least one surface-active foam stabilising component and the at least one antimicrobially active component are contained together in one agent and/or individually in a plurality of agents.

10. A method according to one of claims 8 or 9, characterised in that the aforesaid antimicrobially active component is selected from the groups comprising alcohols, aldehydes, antimicrobial acids, carboxylic acid esters, acid amides, phenols, phenol derivatives, diphenyls, diphenylalkanes, urea derivatives, oxygen/nitrogen acetals and formals, benzamidines, isothiazolines, phthalimide derivatives, pyridine derivatives, guanidines, chlorohexidines, alkylamines, alkyldiamines, alkyltriamines, antimicrobial amphoteric compounds, quinolines, 1,2-dibromo-2,4-dicyanobutane, iodo-2-propynyl butylcarbamate, iodine, iodophores, peroxides and per-acids.

11. A method according to one or more of claims 8 to 10, characterised in that the aforesaid antimicrobially active component is an organic per-acid, preferably selected from among
a) the per-acids or salts of per-acids with the general formula I
R²—O₂C—(CH₂)ₓ—CO₃H (I)
in which R² is hydrogen or an alkyl group of 1 to 4 carbon atoms and x is a number from 1 to 4, and/or
b) phthalimidopercarboxylic acids (II), in which the percarboxylic acid fraction contains 1 to 18 carbon atoms, and/or
c) the compounds of the formula III
R¹—CO₃H (III)
in which R¹ is an alkyl or alkenyl group with 1 to 18 carbon atoms.

12. A method according to claim 11, characterised in that
a)the per-acids of the general formula I are per-acids, in which R² is hydrogen or a methyl group, and/or
b) the per-acids are phthalimido per-acids, in which the percarboxylic acid fraction contains 1 to 8 carbon atoms, and/or
c) the per-acids of the general formula III are per-acids with an alkyl or alkylene group with 1 to 12 carbon atoms.

13. A method according to claim 12, characterised in that the per-acids comprise one or more compounds selected from among peracetic acid, perpropionic acid, peroctanoic acid, phthalimidoperhexanoic acid, phthalimidoperoctanoic acid, persuccinic acid, persuccinic acid monomethyl ester, perglutaric acid, perglutaric acid monomethyl ester, peradipic acid, peradipic acid monomethyl ester, perbutanedioic acid, perbutanedioic acid monomethyl ester.

14. A method according to one or more of claims 8 to 13, characterised in that fatty acids with 8 to 12 carbon atoms are preferably additionally contained in the agents to be used.

15. A method according to one of claims 8 to 14, characterised in that chromophoric components are additionally contained in at least one of the agents to be used.

16. A method according to one of claims 8 to 15, characterised in that the proportion of antimicrobially active component in at least one of the agents to be used is between 0.2 and 30 wt. %, preferably between 2 and 20 wt. %

17. A method according to one of claims 8 to 16, characterised in that the aforesaid surface-active foam stabilising component is selected from the tertiary amine oxides of the general formula (A)
wherein R¹ denotes a saturated or a mono- to triunsaturated branched or unbranched alkyl group with 10 to 20 C atoms and R² and R³ mutually independently denote methyl, ethyl or propyl residues or the hydroxy derivatives thereof and/or the alkylpolyglycosides of the general formula (B)
R⁴—O—(R⁵—O)_{y}(Z)ₓ (B)
wherein R⁴ denotes a monovalent, saturated or unsaturated alkyl or hydroxyalkyl residue comprising 6 to 30 C atoms or an aryl residue, R⁵ denotes a divalent hydrocarbon residue with 2 to 4 C atoms, y denotes a number between 0 and 12, Z a sugar residue with 5 to 6 C atoms and x a number between 1 and 10, and/or the quaternary ammonium compounds of the general formula C
in which the individual parts, independently of one another, have the following meaning:
R⁶=alkyl, alkenyl or aryl group with 1 to 6 C atoms
R⁷,R⁸,R⁹=alkylene group with 2 to 4 C atoms respectively
R¹⁰,R¹¹,R¹²=hydrogen or aliphatic or aromatic acyl group with 6 to 20 C atoms, wherein at most 2 of the residues R⁵ to R⁷ may be hydrogen,
Y^{o}=inorganic or organic anion and/or other quaternary ammonium compounds which are suitable as foam stabilising components.

18. A method according to one of claims 8 to 17, characterised in that the proportion of surface-active foam stabilising component in at least one of the agents to be used amounts to between 0.2 and 20 wt. %, preferably between 1 and 15 wt. %.

19. An agent for preventing hoof infection, containing at least one surface-active foam stabilising component and at least one antimicrobially active component together with at least one chromophoric component.

20. An agent for preventing hoof infection, containing at least one surface-active foam stabilising component and at least one antimicrobially active component selected from
a) the per-acids or salts of per-acids with the general formula I
R²—O₂C—(CH₂)ₓ—CO₃H (I)
in which R² is hydrogen or an alkyl group of 1 to 4 carbon atoms and x is a number from 1 to 4, and/or
b) phthalimidopercarboxylic acids (II), in which the percarboxylic acid fraction contains 1 to 18 carbon atoms, and/or
c) the compounds of the formula III
R¹—CO₃H (III)
in which R¹ is an alkyl or alkenyl group with 1 to 18 carbon atoms.

21. A system for treating the hooves of agricultural animals, in particular in the field of livestock breeding, containing one or more of the agents to be used in accordance with one of claims 8 to 18 and a device for use in accordance with one of claims 6 or 7.

22. A system for treating the hooves of agricultural animals, in particular in the field of livestock breeding, containing one or more of the agents for use accordance with one of claims 8 to 14 and 16 to 18 and a device for use in accordance with one of claims 6 or 7 together with an additional chromophoric agent for separate use in accordance with claim 5.
